(19) United States
(12) Patent Application Publication
(10) Pub. No.: US 2021/0364186 A1
(43) Pub. Date: Nov. 25, 2021

(54) AIR-CONDITIONING SYSTEM AND PROGRAM UPDATE METHOD OF AIR-CONDITIONING SYSTEM

(71) Applicant: Mitsubishi Electric Corporation, Tokyo (JP)

(72) Inventor: Mario SATO, Tokyo (JP)

(21) Appl. No.: 17/256,606

(22) PCT Filed: Aug. 29, 2018
(86) PCT No.: PCT/JP2018/031852

§ 371 Date: Dec. 28, 2020

(51) Int. Cl. F24F 11/65; G05B 19/042

(52) U.S. Cl. CPC F24F 11/65; G05B 2219/2614; G05B 2219/25252; G05B 19/042

(57) ABSTRACT

An air-conditioning system includes equipment, the equipment including one or more pieces of equipment, a high level device configured to control the equipment, a storage device configured to store an update program for updating a control program of an update target device corresponding to the high level device or the equipment and a pre-update program of the update target device, the update program and the pre-update program being previously stored in a server that is externally disposed, an information obtaining unit configured to obtain the update program from the server and also obtain the pre-update program from the update target device, and store the update program and the pre-update program in the storage device, a comparison determination unit configured to compare a version of the update program with a version of the pre-update program, and an update execution unit configured to update, when the version of the pre-update program is older than the version of the update program, the control program of the update target device into the update program stored in the storage device, in which the update execution unit restores, when the update target device in which the control program is updated does not operate normally, the control program of the update target device to the pre-update program stored in the storage device.

### TECHNICAL FIELD

The present disclosure relates to an air-conditioning system in which a program is updated, and a program update method of the air-conditioning system.

### BACKGROUND ART

An air-conditioning system in related art includes an outdoor unit, an indoor unit, and a remote controller, and is configured by connecting these devices to one another by a transmission line. In the air-conditioning system, an air-conditioning operation is performed when each of the outdoor unit, the indoor unit, and the remote controller transmits and receives control signals via the transmission line. Each of the outdoor unit, the indoor unit, and the remote controller includes a control substrate, and a microcomputer having a flash memory built therein is mounted on the control substrate. A control program for controlling each device is written in the flash memory built in the microcomputer.

In some cases, the control program needs an update when a function is improved or a defect is fixed. When the control program is to be updated, normally, an operator shuts down a power source of an update target device, then opens a panel, and connects a program rewriting tool to the control substrate on which the microcomputer is mounted to write a new control program.

However, when the control program is updated as described above, it is necessary to take time to transfer the control program from the program rewriting tool to the flash memory built in the microcomputer. In this case, the operator is occupied until the control program is transferred and the update is ended. In particular, when a plurality of devices are set as program update targets, the operator is occupied until the update of the control programs for the plurality of devices is completed. For this reason, the update of the control programs is not to be efficiently performed.

In view of the above, recently, various methods for efficiently updating the control programs have been proposed. For example, Patent Literature 1 discloses a method of automatically updating control programs of a plurality of air-conditioning controllers. According to the invention described in Patent Literature 1, when the control programs of the plurality of air-conditioning controllers are to be updated, first, the control program of one of the plurality of air-conditioning controllers is manually updated by the operator. Thereafter, the control program after the update is automatically transmitted from the air-conditioning controller in which the control program is updated to an other air-conditioning controller. Then, the other air-conditioning controller that receives the control program after the update updates the control program by using the received control program.

### CITATION LIST

### Patent Literature

Patent Literature 1: Japanese Unexamined Patent Application Publication No. 2007-79764

### SUMMARY OF INVENTION

### Technical Problem

However, according to the method described in Patent Literature 1, one air-conditioning controller needs to be manually updated by the operator first. For this reason, the operator needs to visit a location where the air-conditioning controller of the update target is installed, and it is time consuming to update the control program. In addition, when the update of the control program is not successful, there is a possibility that a defect occurs that the device of the update target does not operate normally. When the defect occurs, the operator needs to work again to make the device operate normally, and this work is time consuming.

The present disclosure has been made in view of the above-described problem, and aims at providing an air-conditioning system in which an operator efficiently updates a control program without visiting a location where equipment of an update target is installed, and a defect that the device of the update target does not operate normally when the update of the control program fails can be eliminated, and a program update method of the air-conditioning system.

### Solution to Problem

An air-conditioning system according to one embodiment of the present disclosure includes one or more pieces of equipment involved in air-conditioning, a high level device connected to the one or more pieces of equipment and configured to control the one or more pieces of equipment, a storage device configured to store, by setting the high level device or the one or more pieces of equipment as an update target device, an update program for updating a control program of the update target device and a pre-update program of the update target device, the update program and the pre-update program being previously stored in a server that is externally disposed, an information obtaining unit configured to obtain the update program from the server and also obtain the pre-update program from the update target device, and store the update program and the pre-update program that are obtained in the storage device, a comparison determination unit configured to compare a version of the update program with a version of the pre-update program, and an update execution unit configured to update, when the version of the pre-update program is older than the version of the update program, the control program of the update target device into the update program stored in the storage device, wherein the update execution unit restores, when the update target device in which the control program is updated does not operate normally, the control program of the update target device to the pre-update program stored in the storage device.

In addition, a program update method of an air-conditioning system according to one embodiment of the present disclosure is a program update method of an air-conditioning system in which one or more pieces of equipment involved in air-conditioning, or a high level device connected to the one or more pieces of equipment and configured to control the one or more pieces of equipment is set as an update target device, and a control program of the update target device is updated, the program update method including a step of obtaining an update program for updating the control program of the update target device from a server that is externally disposed, a step of obtaining a pre-update program from the update target device, a step of comparing a version of the update program with a version of the pre-update program, a step of updating, when the version of the pre-update program is older than the version of the update program, the control program of the update target device to the update program, and a step of restoring, when the update target device in which the control program is updated does not operate normally, the control program of the update target device to the pre-update program.

### Advantageous Effects of Invention

According to one embodiment of the present disclosure, the update program for updating the control program is stored in the server that is externally disposed, and at the time of the update of the control program, the control program of the update target device is updated using the update program stored in the server that is externally disposed. In addition, when the equipment in which the program is updated does not operate normally, the program of the equipment is restored to the pre-update program by using the pre-update program stored in the storage device. With this configuration, since the control program of the update target device is automatically updated, the operator can efficiently perform the update of the control program without visiting the location where the update target device is installed, and also the defect that the device of the update target does not operate normally when the update of the control program fails can be eliminated.

### BRIEF DESCRIPTION OF DRAWINGS

FIG. 1 is a block diagram illustrating an example of a configuration of an air-conditioning system according to Embodiment 1.

FIG. 2 is a block diagram illustrating an example of a configuration of an outdoor unit of FIG. 1.

FIG. 3 is a functional block diagram illustrating an example of a configuration of a microcomputer of FIG. 2.

FIG. 4 is a hardware configuration diagram illustrating an example of a configuration of a control substrate of FIG. 2.

FIG. 5 is a block diagram illustrating an example of a configuration of an indoor unit of FIG. 1.

FIG. 6 is a flowchart illustrating an example of a flow of program update processing by the outdoor unit of FIG. 1.

FIG. 7 is a flowchart illustrating an example of a flow of processing for restoring an updated program to a program before update.

FIG. 8 is a flowchart illustrating an example of a flow of the program update processing according to Embodiment 2.

FIG. 9 is a block diagram illustrating an example of a configuration of an air-conditioning system according to Embodiment 3.

FIG. 10 is a block diagram illustrating an example of a configuration of an air-conditioning system according to Embodiment 4.

FIG. 11 is a functional block diagram illustrating an example of a configuration of a microcomputer disposed in the outdoor unit of FIG. 10.

FIG. 12 is a schematic diagram illustrating an example of device update data.

FIG. 13 is a flowchart illustrating an example of a flow of program re-update processing by the outdoor unit of FIG. 10.

### DESCRIPTION OF EMBODIMENTS

### Embodiment 1

Hereinafter, an air-conditioning system according to Embodiment 1 of the present disclosure will be described. The air-conditioning system according to present Embodiment 1 includes one or more indoor units serving as equipment involved in air-conditioning, and an outdoor unit connected to the one or plurality of indoor units and serving as a high level device configured to control the one or plurality of indoor units,

### [Configuration of Air-Conditioning System 100]

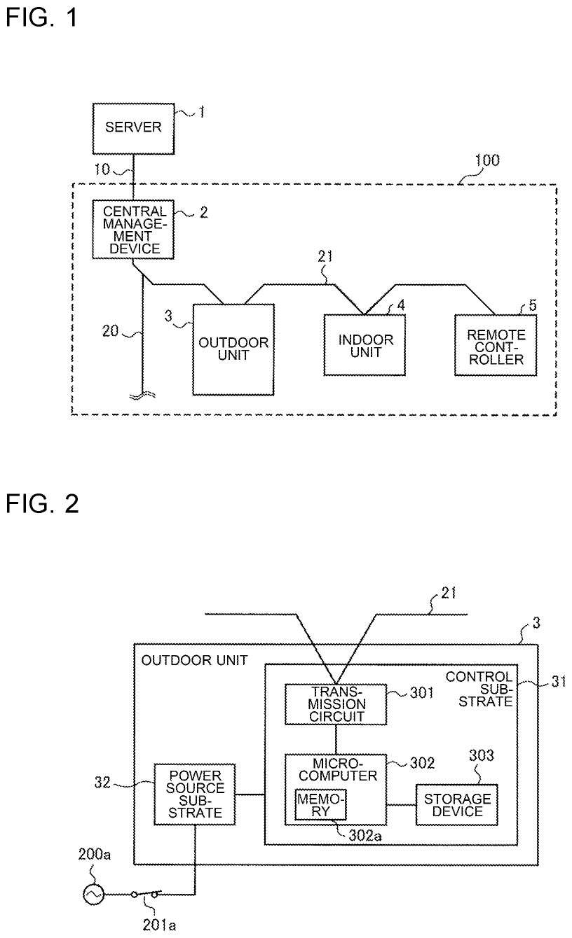

FIG. 1 is a block diagram illustrating an example of a configuration of an air-conditioning system 100 according to present Embodiment 1. As illustrated in FIG. 1, the air-conditioning system 100 includes a central management device 2, an outdoor unit 3, an indoor unit 4, and a remote controller 5. The central management device 2 is connected, by a local area network (LAN) 10 or other networks, to a server 1 that is externally disposed. The central management device 2 and the outdoor unit 3 are connected to each other by the communication cable 20. The outdoor unit 3, the indoor unit 4, and the remote controller 5 are connected to one another by a communication cable 21. It is noted that in the air-conditioning system 100, the number of the outdoor unit 3, the number of the indoor unit 4, and the number of the remote controller 5 are not limited to the numbers in this example, and any number of devices may also be used. In addition, a connection method of the remote controller 5 is not limited to a case where the remote controller 5 is connected by a wired manner using the communication cable 21 or other cables, and the remote controller 5 may also be connected in a wireless manner using a wireless communication or other communication methods.

The server 1 previously stores a control program (hereinafter, referred to as an “update program”) for updating a control program of each device included in the air-conditioning system 100. When the control program is to be updated, the server 1 transmits the update program to the outdoor unit 3 via the central management device 2.

The central management device 2 transmits and receives various types of data with the outdoor unit 3 via the communication cable 20 to manage and control the outdoor unit 3 and the indoor unit 4 connected to the outdoor unit 3. For example, the central management device 2 receives information indicating states of the outdoor unit 3 and the indoor unit 4 and also transmits control signals for controlling these units via the communication cable 20.

The outdoor unit 3 performs an air-conditioning operation in cooperation with the indoor unit 4 based on the control signals received from the central management device 2 via the communication cable 20. In addition, when the air-conditioning operation is performed, the outdoor unit 3 transmits, to the central management device 2 via the communication cable 20, signals including data needed for the central management device 2 to perform the control. In addition, according to present Embodiment 1, the outdoor unit 3 receives, via the central management device 2, the update program transmitted from the server 1. Then, the outdoor unit 3 updates its own control program based on the received update program.

The indoor unit 4 is installed in an air-conditioned space, and performs air-conditioning in the air-conditioned space based on the control from the outdoor unit 3. For example, the indoor unit 4 performs various operations such as a cooling operation and a heating operation while each unit in its own device is controlled based on the control signals from the outdoor unit 3.

The remote controller 5 is disposed to operate the air-conditioning system 100, and transmits operation signals according to operations by a user to the outdoor unit 3 and the indoor unit 4 via the communication cable 21. For example, when the user operates the remote controller 5, an indoor temperature at the time of the cooling operation or the heating operation for the air-conditioned space is set.

### (Outdoor Unit 3)

FIG. 2 is a block diagram illustrating an example of a configuration of the outdoor unit 3 of FIG. 1. As illustrated in FIG. 2, the outdoor unit 3 has a control substrate 31 and a power source substrate 32.

The control substrate 31 is disposed to control the outdoor unit 3, and has a transmission circuit 301, a microcomputer 302, and a storage device 303. Various functions of the control substrate 31 are realized by executing software on an arithmetic device such as a microcomputer, or the control substrate 31 is configured by hardware such as a circuit device that realizes the various functions.

The transmission circuit 301 is an interface configured to perform a communication with the indoor unit 4 and the remote controller 5 via the communication cable 21. The transmission circuit 301 is connected to the microcomputer 302. The microcomputer 302 controls various operations in the outdoor unit 3, and also executes various functions. The microcomputer 302 has a memory 302a built therein. The memory 302a is, for example, a flash memory, and stores a control program for controlling the outdoor unit 3.

The storage device 303 is configured, for example, by a non-volatile memory, and temporarily stores an update program used to update the control program of the outdoor unit 3. In addition, the storage device 303 temporarily stores a pre-update program of the outdoor unit 3 and setting information data. The setting information data is, for example, data including setting information at the time of the operation, such as validation or invalidation of a power saving function. It is noted that as the storage device 303, for example, an external storage medium that is detachable such as a universal serial bus (USB) memory or a secure digital (SD) card may also be used.

The power source substrate 32 is supplied with a commercial power source 200a via a switch 201a. The power source substrate 32 converts electric power supplied from the commercial power source 200a into direct current power adapted to the control substrate 31, and supplies the direct current power to the control substrate 31.

### (Microcomputer 302)

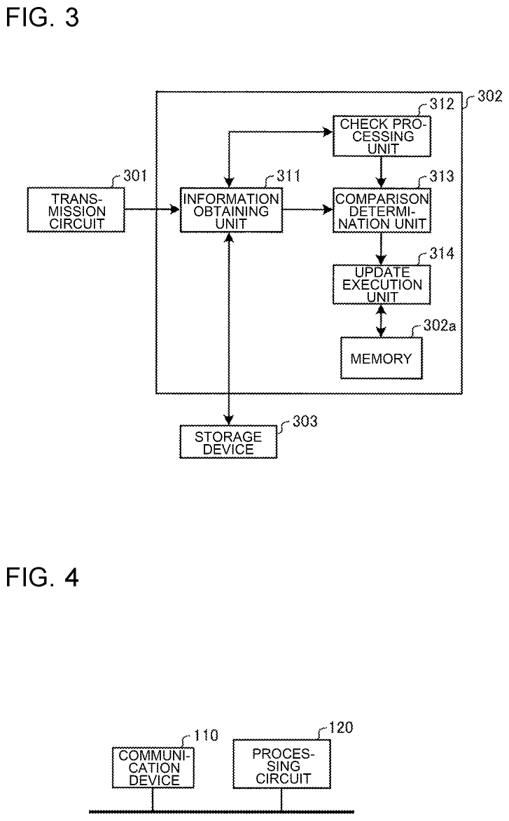

FIG. 3 is a functional block diagram illustrating an example of a configuration of the microcomputer 302 of FIG. 2. As illustrated in FIG. 3, the microcomputer 302 has an information obtaining unit 311, a check processing unit 312, a comparison determination unit 313, an update execution unit 314, and the memory 302a.

The information obtaining unit 311 obtains the update program from the server 1 via the transmission circuit 301. The check processing unit 312 checks whether or not the update program is saved in the server 1 via the transmission circuit 301. In addition, when the control program of the outdoor unit 3 is updated, the check processing unit 312 checks an operation state as to whether or not the outdoor unit 3 operates normally.

The comparison determination unit 313 compares a version of the update program obtained from the server 1 with a version of the pre-update program of the outdoor unit 3, and determines which version of the program is newer than the other The update execution unit 314 executes the update processing of the control program stored in the memory 302a based on the update program obtained from the server 1. In addition, the update execution unit 314 controls the operation of the outdoor unit 3 and stopping of the operation.

As described above, the various functions of the microcomputer 302 are executed by software, the functions of the information obtaining unit 311, the check processing unit 312, the comparison determination unit 313, and the update execution unit 314 are realized by software, firmware, or a combination of software and firmware. The software and the firmware are written as a program and stored in the memory 302a. The microcomputer 302 reads out and executes the program stored in the memory 302a, so that the functions of the respective units are realized.

As the memory 302a, for example, a non-volatile or volatile semiconductor memory such as a random access memory (RAM), a read only memory (ROM), a flash memory, an erasable and programmable ROM (EPROM), and an electrically erasable and programmable ROM (EEPROM) or other memories are used. In addition, as the memory 302a, for example, a recording medium that is detachable such as a magnetic disc, a flexible disc, an optical disc, a compact disc (CD), a mini disc (MD), and a digital versatile disc (DVD) may also be used.

FIG. 4 is a hardware configuration diagram illustrating an example of a configuration of the control substrate 31 of FIG. 2. When the various functions of the control substrate 31 are executed by hardware, as illustrated in FIG. 4, the control substrate 31 of FIG. 2 is configured by a communication device 110 and a processing circuit 120. The transmission circuit 301 of FIG. 2 corresponds to the communication device 110 of FIG. 4. In addition, the respective functions of the information obtaining unit 311, the check processing unit 312, the comparison determination unit 313, and the update execution unit 314 in the microcomputer 302 of FIG. 3 are realized by the processing circuit 120.

When the respective functions are executed by hardware, the processing circuit 120 corresponds, for example, to a single circuit, a combined circuit, a programmed processor, a parallel programmed processor, an application specific integrated circuit (ASIC), a field-programmable gate array (FPGA), or a combination of these. Each of the functions of the respective units of the information obtaining unit 311, the check processing unit 312, the comparison determination unit 313, and the update execution unit 314 may also be realized by the processing circuit 120, and the functions of the respective units may also be realized by the processing circuit 120.

### (Indoor Unit 4)

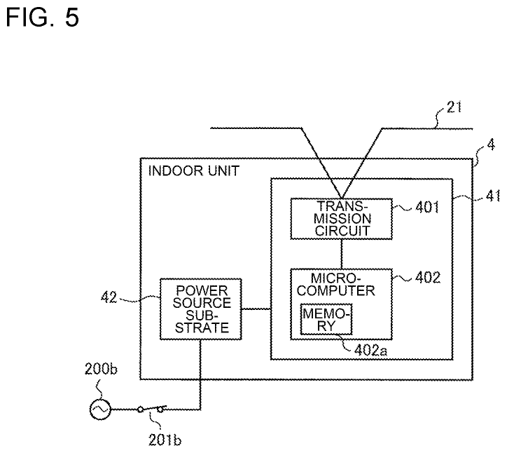

FIG. 5 is a block diagram illustrating an example of a configuration of the indoor unit 4 of FIG. 1. As illustrated in FIG. 5, the indoor unit 4 has a control substrate 41 and a power source substrate 42.

The control substrate 41 is disposed to control the indoor unit 4, and has a transmission circuit 401 and a microcomputer 402. Various functions of the control substrate 41 are realized by executing software on an arithmetic device such as a microcomputer, or the control substrate 41 is configured by hardware such as a circuit device that realizes the various functions.

The transmission circuit 401 is an interface configured to communicate with the outdoor unit 3 and the remote controller 5 via the communication cable 21. The transmission circuit 401 is connected to the microcomputer 402. The microcomputer 402 controls various operations in the indoor unit 4, and also executes various functions. The microcomputer 402 has a memory 402a built therein. The memory 402a is, for example, a flash memory, and stores a control program for controlling the indoor unit 4.

The power source substrate 42 is supplied with a commercial power source 200b via a switch 201b. The power source substrate 42 converts electric power supplied from the commercial power source 200b into direct current power adapted to the control substrate 41, and supplies the direct current power to the control substrate 41.

### [Operation of Air-Conditioning System 100]

An operation of the air-conditioning system 100 that has the above-described configuration will be described. Herein, an operation of the air-conditioning system 100 at the time of ordinary use and for program update processing updating the control program of the outdoor unit 3 will be described.

### (At Time of Ordinary Use)

First, at the time of the ordinary use, the switch 201a for the outdoor unit 3 and the switch 201b for the indoor unit 4 are turned on. With this configuration, the outdoor unit 3 and the indoor unit 4 are in an energized state.

In the outdoor unit 3, when the switch 201a is turned on, electric power is supplied from the commercial power source 200a to the power source substrate 32. The power source substrate 32 converts the supplied electric power of the commercial power source 200a into direct current power adapted to be used in the control substrate 31. Then, the power source substrate 32 supplies the direct current to the microcomputer 302 and the transmission circuit 301 of the control substrate 31.

In addition, in the indoor unit 4, when the switch 201b is turned on, electric power is supplied from the commercial power source 200b to the power source substrate 42. The power source substrate 42 converts the supplied electric power of the commercial power source 200b into direct current power adapted to be used in the control substrate 41. Then, the power source substrate 42 supplies the direct current to the microcomputer 402 and the transmission circuit 401 of the control substrate 41.

On the other hand, when the user operates the remote controller 5, operation information input to the remote controller 5 is transmitted to the microcomputer 402 of the indoor unit 4 via the communication cable 21 and the transmission circuit 401. The microcomputer 402 controls the indoor unit 4 based on the operation information transmitted from the remote controller 5. In addition, the microcomputer 402 transmits information necessary for air-conditioning control by the outdoor unit 3 to the microcomputer 302 of the outdoor unit 3 via the transmission circuit 401, the communication cable 21, and the transmission circuit 301.

The microcomputer 302 of the outdoor unit 3 controls the outdoor unit 3 based on the information necessary for the air-conditioning control that is transmitted from the microcomputer 402 of the indoor unit 4. In addition, the microcomputer 302 transmits information necessary for air-conditioning control by the indoor unit 4 to the microcomputer 402 via the transmission circuit 301, the communication cable 21, and the transmission circuit 401. In this manner, the air-conditioning is performed while each of the outdoor unit 3, the indoor unit 4, and the remote controller 5 transmits the information necessary for the air-conditioning control via the communication cable 21.

### (Program Update Processing)

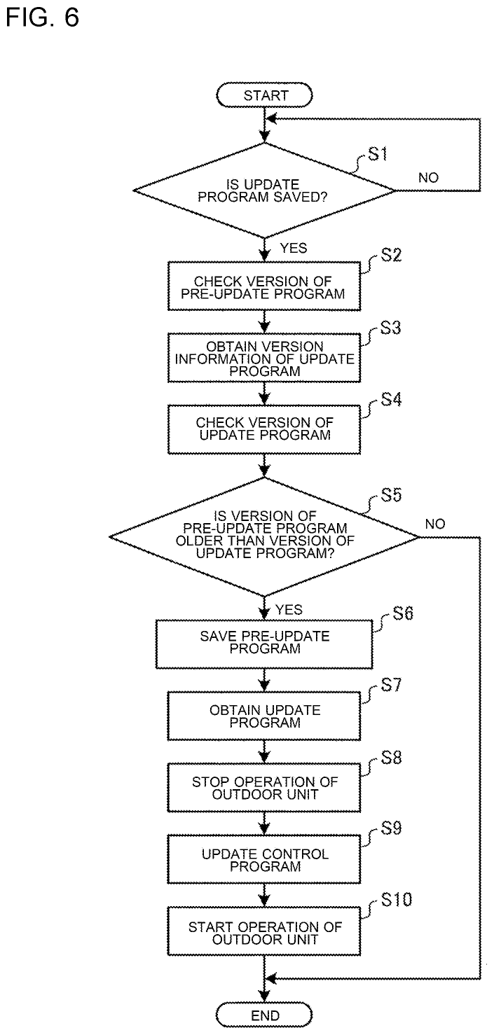

FIG. 6 is a flowchart illustrating an example of a flow of the program update processing by the outdoor unit 3 of FIG. 1. First, in step S1, the check processing unit 312 of the outdoor unit 3 determines whether or not the update program is saved in the server 1. When the update program is not saved in the server 1 (step S1; No), the processing returns to step S1, and the processing in step S1 is repeated until the update program is saved in the server 1. On the other hand, when the update program is saved in the server 1 (step S1; Yes), the control program update processing is started.

It is noted that the control program update processing is performed by determining whether or not the update program is saved in the server 1, but the configuration is not limited to this example. For example, when a program for starting the update of the control program is executed after the update program is saved in the server 1 by an operator, the control program update processing may also be started.

In step S2, the check processing unit 312 obtains and checks version information of a current control program (pre-update program) stored in the memory 302a. In addition, in step S3, the information obtaining unit 311 obtains version information of the update program from the server 1 via the transmission circuit 301. Then, in step S4, the check processing unit 312 checks the version information of the update program.

Next, in step S5, the comparison determination unit 313 compares the version of the pre-update program with the version of the update program, and determines whether or not the version of the pre-update program is older than the version of the update program. When the version of the pre-update program is older than the version of the update program (step S5; Yes), the comparison determination unit 313 saves the pre-update program in the storage device 303 in step S6. On the other hand, when the version of the pre-update program is the same as or newer than the version of the update program (step S5; No), the series of processes is ended.

In step S7, the information obtaining unit 311 obtains the update program from the server 1 via the transmission circuit 301, and saves the update program in the storage device 303. Then, in step S8, the update execution unit 314 stops the operation of the outdoor unit 3. In step S9, the update execution unit 314 overwrites and saves the update program that is saved in the storage device 303, in the memory 302a. With this configuration, the control program of the outdoor unit 3 is updated. In step S10, the update execution unit 314 restarts the outdoor unit 3, and resumes the operation.

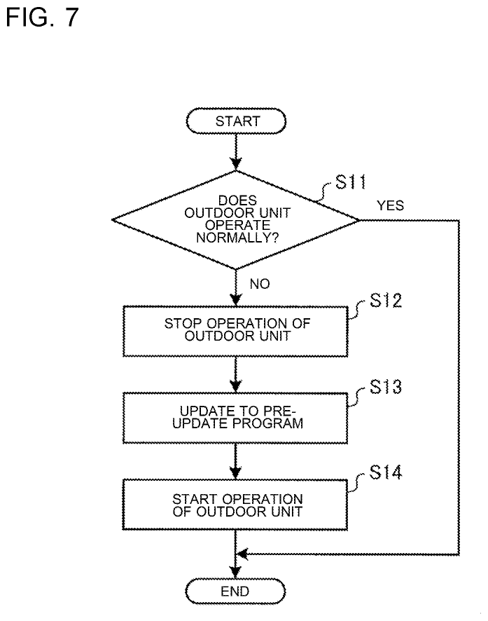

Herein, after the control program is updated, there is a possibility that the outdoor unit 3 does not operate normally. In the above-mentioned case, the outdoor unit 3 performs processing for restoring the control program with which the outdoor unit 3 does not operate normally to the pre-update program. FIG. 7 is a flowchart illustrating an example of a flow of processing for restoring the updated program to the program before the update.

In step S11, the check processing unit 312 determines whether or not the outdoor unit 3 operates normally. When the outdoor unit 3 does not operate normally because of the update of the control program (step S11; No), the processing shifts to step S12. On the other hand, when the outdoor unit 3 operates normally (step S11; Yes), the series of processes is ended.

In step S12, the update execution unit 314 stops the operation of the outdoor unit 3. In step S13, the update execution unit 314 obtains the pre-update program of the outdoor unit 3 that is saved in the storage device 303, and overwrites and saves the obtained pre-update program in the memory 302a. With this configuration, the control program of the outdoor unit 3 is restored to the pre-update program. In step S14, the update execution unit 314 restarts the outdoor unit 3 after the program is restored to the pre-update program, and resumes the operation.

In this manner, according to present Embodiment 1, the update program stored in the server 1 is transmitted to the outdoor unit 3, and the control program of the outdoor unit 3 is updated to the update program. With this configuration, the operator can update the control program of the outdoor unit 3 by simply saving the update program in the server 1 or thereafter executing the start of the control program update processing. In other words, according to present Embodiment 1, the operator can efficiently update the control program without visiting a location where the equipment of the update target is installed.

As described above, in the air-conditioning system 100 according to present Embodiment 1, the update program for updating the control program is previously stored in the server 1 that is externally disposed. Then, the outdoor unit 3 serving as a high level device updates the control program of the outdoor unit 3 itself set as the update target device by using the update program stored in the server 1 at the time of the update of the control program. With this configuration, since the control program of the outdoor unit 3 is automatically updated, the operator can efficiently update the control program without visiting the location where the outdoor unit 3 is installed.

### Embodiment 2

Next, Embodiment 2 of the present disclosure will be described. Embodiment 2, is different from Embodiment 1 in that the control programs of the indoor unit 4 and the remote controller 5 are updated based on the control of the outdoor unit 3. It is noted in the following description, parts common to the parts of Embodiment 1 are assigned with the same reference signs, and the detailed description will be omitted. In addition, hereinafter, a case will be described as an example where the control program of the indoor unit 4 is to be updated.

### [Configuration of Air-Conditioning System 100]

The air-conditioning system 100 according to present Embodiment 2 has a configuration similar to the air-conditioning system 100 according to Embodiment 1 illustrated in FIG. 1. It is noted that the server 1 previously stores device specification information indicating the equipment set as the update target in addition to the update program. When the control program is to be updated, the server 1 transmits the update program and the device specification information to the outdoor unit 3 via the central management device 2.

### [Operation of Air-Conditioning System 100]

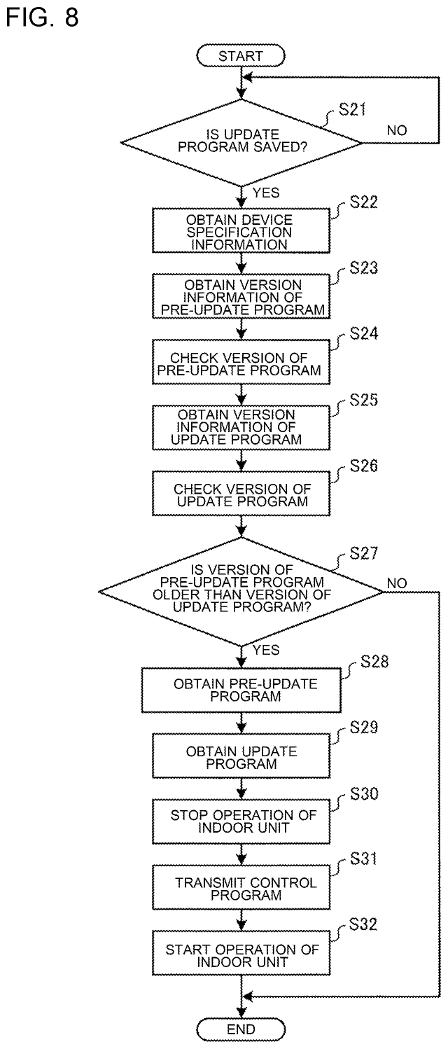

The program update processing by the air-conditioning system 100 according to present Embodiment 2 will be described. FIG. 8 is a flowchart illustrating an example of a flow of the program update processing according to present Embodiment 2. Herein, a case will be described as an example where the control program of the indoor unit 4 is updated.

First, in step S21, the check processing unit 312 of the outdoor unit determines whether or not the update program is saved in the server 1. When the update program is not saved in the server 1 (step S21; No), the processing returns to step S21, and the processing in step S21 is repeated until the update program is saved in the server 1. On the other hand, when the update program is saved in the server 1 (step S21; Yes), the control program update processing is started.

In step S22, the information obtaining unit 311 obtains the device specification information from the server 1. In step S23, the information obtaining unit 311 obtains version information of the pre-update program from the indoor unit 4 set as the update target based on the obtained device specification information. In step S24, the check processing unit 312 checks the obtained version information of the pre-update program in the indoor unit 4.

In addition, in step S25, the information obtaining unit 311 obtains version information of the update program from the server 1 via the transmission circuit 301. Then, in step S26, the check processing unit 312 checks the version information of the update program.

Next, in step S27, the comparison determination unit 313 compares the version of the pre-update program with the version of the update program, and determines whether or not the version of the pre-update program is older than the version of the update program. When the version of the pre-update program is older than the version of the update program (step S27; Yes), in step S28, the information obtaining unit 311 obtains the pre-update program from the indoor unit 4, and saves the pre-update program in the storage device 303. On the other hand, when the version of the pre-update program is the same as or newer than the version of the update program (step S27; No), the series of processes is ended.

In step S29, the information obtaining unit 311 obtains the update program from the server 1 via the transmission circuit 301, and saves the update program in the storage device 303. Then, in step S30, the update execution unit 314 stops the operation of the indoor unit 4, and in step S31, transmits the update program saved in the storage device 303 to the indoor unit 4.

At this time, when the update program is received from the outdoor unit 3, the indoor unit 4 overwrites and saves the received update program in the memory 402a. With this configuration, the control program of the indoor unit 4 is updated.

In step S32, when the update of the control program by the indoor unit 4 is ended, the update execution unit 314 restarts the indoor unit 4 and resumes the operation.

In this manner, according to present Embodiment 2, the update program stored in the server 1 is saved in the outdoor unit 3 and then transmitted to the indoor unit 4, and the control program of the indoor unit 4 is updated to the update program. It is noted that also when the control program of the remote controller 5 is to be updated, the control program of the remote controller 5 is updated by performing processing similar to the processing illustrated in FIG. 8 on the remote controller 5.

In other words, according to present Embodiment 2, it is possible to update the control programs of the indoor unit 4 and the remote controller 5 serving as the equipment based on the control of the outdoor unit 3. In addition, as in Embodiment 1, the operator can update the control programs of the indoor unit 4 and the remote controller 5 by simply saving the update program in the server 1, or thereafter executing the start of the control program update processing. For this reason, according to present Embodiment 1, the operator can efficiently update the control programs of the equipment without visiting the location where the equipment of the update target is installed.

As described above, in the air-conditioning system 100 according to present Embodiment 2, the outdoor unit 3 serving as the high level device updates the control program of the indoor unit 4 or the remote controller 5 serving as the equipment by using the update program stored in the server 1. With this configuration, since the control program of the indoor unit 4 or the remote controller 5 is automatically updated, the operator can efficiently update the control program without visiting the location where the indoor unit 4 or the remote controller 5 is installed.

### Embodiment 3

Next, Embodiment 3 of the present disclosure will be described. Embodiment 3 is different from Embodiments 1 and 2 in that, when the control program of the outdoor unit 3, the indoor unit 4, or the remote controller 5 is to be updated, the update program and the pre-update program are saved in the server 1. It is noted in the following description, the parts common to the parts according to Embodiments 1 and 2 are assigned with the same signs, and the detailed description will be omitted.

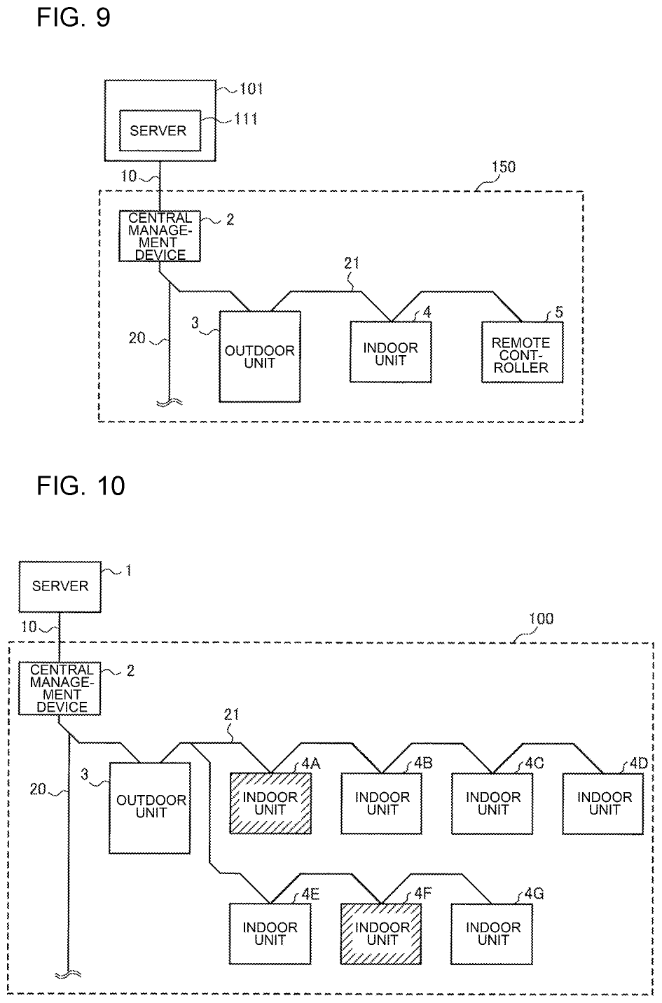

FIG. 9 is a block diagram illustrating an example of a configuration of an air-conditioning system 150 according to present Embodiment 3. As illustrated in FIG. 9, the air-conditioning system 150 includes the central management device 2, the outdoor unit 3, the indoor unit 4, and the remote controller 5. The central management device 2 is connected by the LAN 10 or other networks to a server 101 that is externally disposed.

The server 101 has a server side storage device 111. When the control program of the outdoor unit 3, the indoor unit 4, or the remote controller 5 is to be updated, the server 101 saves the pre-update program obtained from the equipment of the update target in the server side storage device 111 instead of the storage device 303. It is noted that the update program is previously stored in the server 101 as in Embodiments 1 and 2.

Specifically, when the control program of the update target device is to be updated, the information obtaining unit 311 of the outdoor unit 3 saves the pre-update program obtained from the indoor unit 4 in the server side storage device 111 instead of the storage device 303. The update execution unit 314 transmits the update program saved in the server side storage device 111 to the indoor unit 4. In addition, when the control program of the update target device is restored to the pre-update program, the update execution unit 314 obtains the pre-update program of the outdoor unit 3 saved in the server side storage device 111, and restores the control program of the update target device to the pre-update program by using the obtained pre-update program.

With this configuration, the storage device 303 disposed in the outdoor unit 3 does not need to have a saving space of the update program and the pre-update program. For this reason, a device having a low capacity can be used as the storage device 303.

It is noted that when the update program and the pre-update program are saved in the server 101, a communication is performed between the server 101 and the outdoor unit 3. In this case, since there is a possibility that a period of time spent for updating the control program is lengthened depending on a situation of a communication traffic, it is necessary to take into account an influence on the communication traffic.

In other words, when the pre-update program is transmitted from the outdoor unit 3 to the server 101, it is preferable to suppress the influence on the communication traffic by adopting a high speed communication, compressing the pre-update program and dividing and transmitting the update program, performing the update of the control program in a time slot when the influence on the communication is small, for example. In addition, when the pre-update program is saved in a device that is located as dose to the equipment of the update target as possible and also has a free storage capacity, the influence on the communication traffic is decreased, and this configuration is further preferable.

As described above, in the air-conditioning system 150 according to present Embodiment 3, the update program and the pre-update program are saved in the server 101. Then, the outdoor unit 3 serving as the high level device updates the control program of the update target device by using the update program saved in the server 101. With this configuration, as in Embodiments 1 and 2, the operator can efficiently perform the update of the control program without visiting the location where the update target device is installed. In addition, since the update program and the pre-update program are saved in the server side storage device 111 of the server 101, the saving space of the update program and the pre-update program in the storage device 303 of the outdoor unit 3 is not needed, and the device having the low capacity can be used as the storage device 303.

### Embodiment 4

Next, Embodiment 4 of the present disclosure will be described. Embodiment 4 is different from Embodiments 1 to 3 in that the re-update of the control program is attempted when the update of the control program for the indoor unit fails. It is noted in the following description, the parts common to the parts according to Embodiments 1 to 3 are assigned with the same signs, and the detailed description will be omitted.

### [Configuration of Air-Conditioning System 100]

FIG. 10 is a block diagram illustrating an example of a configuration of the air-conditioning system 100 according to present Embodiment 4. The air-conditioning system 100 illustrated in FIG. 10 has a configuration similar to the air-conditioning system 100 according to Embodiments 1 and 2 illustrated in FIG. 1. FIG. 10 illustrates a case where a plurality of indoor units 4A to 4G are connected to the outdoor unit 3. Herein, a case will be described as an example where control programs of the indoor units 4A to 4G are updated.

In this example, the indoor units 4A and 4F that are shaded in the drawing represent indoor units in which the update of the control program fails according to present Embodiment 4. It is noted that the air-conditioning system 100 is not limited to this example, and may also have a configuration similar to the air-conditioning system 150 according to Embodiment 3 illustrated in FIG. 9, for example.

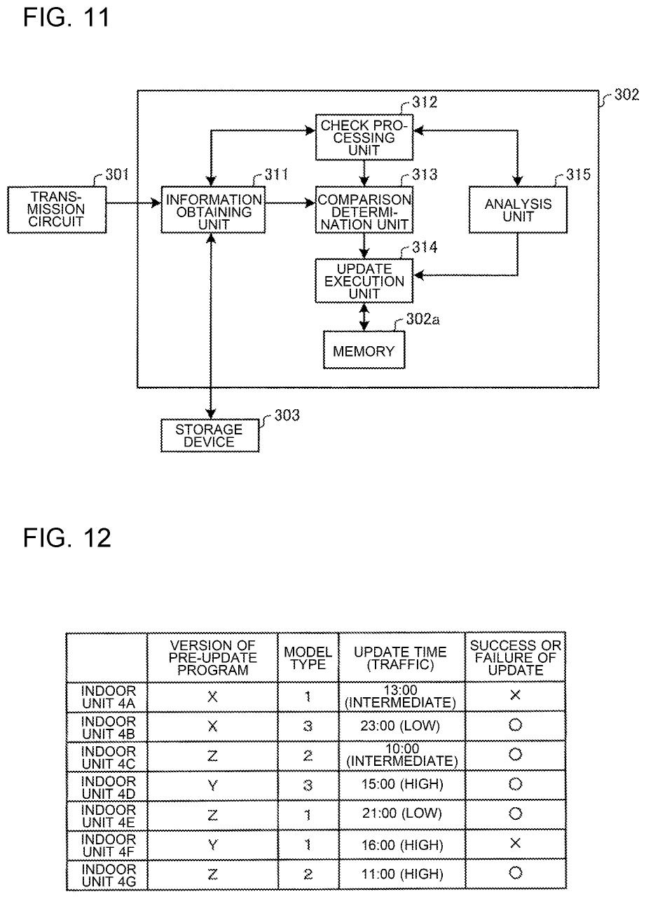

FIG. 11 is a functional block diagram illustrating an example of a configuration of the microcomputer 302 disposed in the outdoor unit 3 of FIG. 10. As illustrated in FIG. 11, the microcomputer 302 has the information obtaining unit 311, the check processing unit 312, the comparison determination unit 313, the update execution unit 314, an analysis unit 315, and the memory 302a.

As described in Embodiment 2, the information obtaining unit 311 receives device update data in addition to the pre-update programs from the indoor units 4A to 4G. The device update data is data indicating parameters that affect the update when the control program of each of the indoor units 4A to 4G is updated and an update state. The check processing unit 312 checks the success or failure of the control program update in the indoor units 4A to 4G based on the device update data received by the information obtaining unit 311.

The analysis unit 315 analyzes a correlation relationship between various types of information based on various parameters included in the device update data and the success or failure of the control program update. When it is determined that the correlation relationship exists based on the analysis result of the correlation relationship that is obtained by the analysis unit 315, the update execution unit 314 performs processing for re-updating the control programs of the indoor units 4A to 4G of the targets. In addition, when it is determined that the correlation relationship does not exist or the re-update of the control program fails, the update execution unit 314 performs processing for restoring the control programs of the indoor units 4A to 4G of the targets to the pre-update programs.

### (Device Update Data)

FIG. 12 is a schematic diagram illustrating an example of the device update data. As illustrated in FIG. 12, the device update data includes the version of the pre-update program in each of the indoor units 4A to 4G, various parameters such as a model type of the indoor unit and an update time, and information indicating the success or failure of the control program update. The version of the pre-update program is information indicating a version of the control program before the update of the control program is performed. The model type is information indicating a model type of the relevant indoor unit. The update time is information indicating a time when the update of the control program is executed. The update time may also include information indicating a transmission traffic at this time. The success or failure of the update is information indicating a result of the execution of the update of the control program.

In the example illustrated in FIG. 12, for example, it is indicated with regard to the indoor unit 4A that the version of the pre-update program is “X”, the model type is “#1”, the update time is “13:00 (transmission traffic: intermediate)”, and the control program update fails. In addition, it is indicated with regard to the indoor unit 4B that the version of the pre-update program is “X”, the model type is “#3”, the update time is “23:00 (transmission traffic: low)”, and the program update is successful.

### [Operation of Air-Conditioning System 100]

The operation of the air-conditioning system 100 that has the above-mentioned configuration will be described. According to present Embodiment 4, when the control program update fails in any of the indoor units 4A to 4G, control program re-update processing for attempting program re-update is performed,

### (Program Re-Update Processing)

The program re-update processing is performed after the control program update of all of the indoor units 4A to 4G set as the control program update targets is ended. First, the microcomputer 302 receives the device update data via the information obtaining unit 311 from each of the indoor units 4A to 4G in which the update of the control program is performed. The information obtaining unit 311 supplies the received device update data to the check processing unit 312.

The check processing unit 312 determines whether or not the control program update of all of the indoor units 4A to 4G is successful based on the received device update data. When any indoor unit in which the update of the control program fails exists among all of the indoor units 4A to 4G, the check processing unit 312 supplies the device update data to the analysis unit 315.

The analysis unit 315 extracts a correlation relationship between the various parameters included in the received device update data and the information indicating the success or failure of the control program update, and analyzes the extracted correlation relationship of the various types of information. For example, the analysis unit 315 analyzes a correlation relationship between information related to the indoor unit in which the update of the control program is successful and information related to the indoor unit in which the update of the control program fails. As a result of the analysis, when the correlation relationship exists in the various types of information, the update execution unit 314 performs processing for re-updating the control program for the indoor unit set as the target. On the other hand, when the correlation relationship does not exist in the various types of information or the control program update still fails after the re-update of the control program is performed, as in Embodiment 1, the update execution unit 314 performs the processing for restoring the control program to the pre-update program.

Herein, with reference to FIG. 12, a specific example of the program re-update processing will be described. For example, when attention is paid to the indoor unit 4A and the indoor unit 4B, the version of the pre-update program in both the two indoor units is “X”. The control program update in the indoor unit 4B is successful, but the control program update in the indoor unit 4A fails. In view of the above, the update execution unit 314 of the microcomputer 302 performs the program re-update processing on the indoor unit 4A, and attempts the re-update of the control program.

At this time, the update time when the program update processing is executed varies in the indoor unit 4A and the indoor unit 4B, and it is considered that there is a possibility that the transmission traffic at the time of the update affects the success or failure of the control program update. Therefore, when the program re-update processing is performed on the indoor unit 4A, the update execution unit 314 performs the program re-update processing on the indoor unit 4A at a timing close to the update time when the control program of the indoor unit 4B is updated or at a timing at which the transmission traffic is dose to the transmission traffic when the control program of the indoor unit 4B is updated.

It is noted that in this case too, when the control program update fails, it is considered that there is a possibility that a difference of a model type of the indoor unit affects the success or failure of the control program update. However, since the model type of the indoor unit cannot be changed, in this case, the update execution unit 314 suspends the update of the control program.

Similarly, when attention also is paid to the indoor unit 4D and the indoor unit 4F, the version of the pre-update program is “Y” in both the two indoor units. The control program update in the indoor unit 4D is successful, but the control program update in the indoor unit 4F fails. It is noted that since the program update processing is performed at timings at which the transmission traffics are comparable to each other in the indoor unit 4D and the indoor unit 4F, it is considered that there is a possibility that the difference of the model type of the indoor unit affects the success or failure of the control program update. Therefore, in this case too, the update execution unit 314 suspends the update of the control program.

Next, when attention is paid to the version of the pre-update program in all of the indoor units 4A to 4G, the update of the control program is successful in all of the indoor unit 4C, the indoor unit 4E, and the indoor unit 4G in which the version of the pre-update program is “Z”. From this, it is considered that there is a possibility that the update of the control program may be successful by updating the control program from the pre-update program in which the version is “Z”. In view of the above, the update execution unit 314 performs processing on the indoor unit 4A and the indoor unit 4F in which the update of the control program fails for updating the control program to the control program in which the version is “Z”, and then updating the control program to the latest control program.

It is noted that in this example, the information illustrated in FIG. 12 is used as the parameters affecting the success or failure of the control program update, but the configuration is not limited to this example. For example, the program re-update processing may also be performed based on a commonality and a difference that are obtained from various pieces of information related to the indoor units in which the control programs are updated using artificial intelligence.

In addition, the analysis result by the analysis unit 315 may also be stored in the storage device 303, for example, and fed back to a creation source of the update program. In addition, when the program update processing performed on all of the indoor units 4A to 4G fails, by taking into account of a possibility of a defect of the update program itself, the analysis result may also be fed back to the creation source of the update program. With this configuration, the program creation source can study and create a subsequent renewed update program based on the information related to the update.

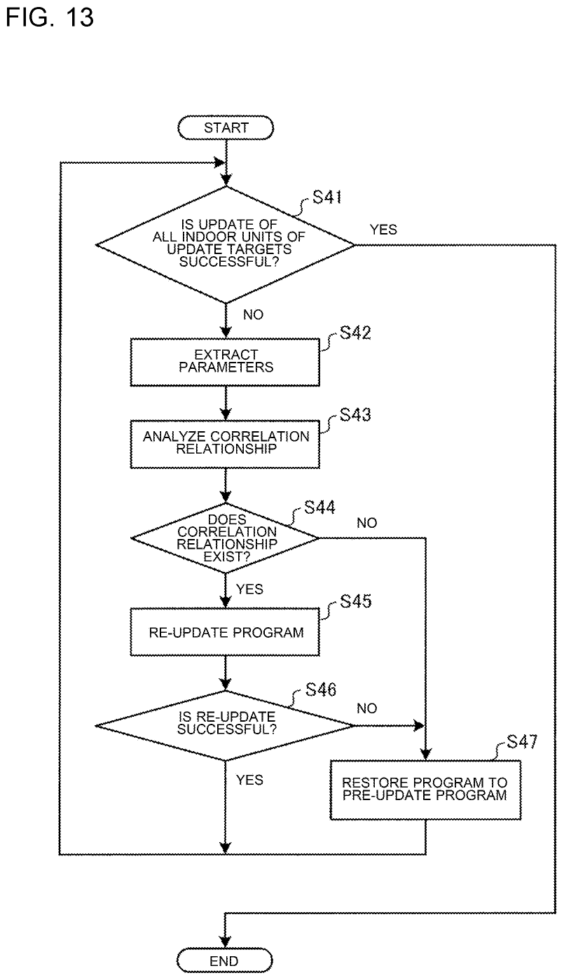

FIG. 13 is a flowchart illustrating an example of a flow of the program re-update processing by the outdoor unit 3 of FIG. 10. In step S41, the check processing unit 312 determines whether or not the control program update of all of the indoor units 4A to 4G is successful based on the device update data received from each of the indoor units 4A to 4G via the information obtaining unit 311. It is noted that herein, also when the control program of the indoor unit is restored to the pre-update program in step S47 that will be described below, this case is similarly treated as the success of the control program update.

When it is determined that the control program update of all of the indoor units 4A to 4G is successful (step S41; Yes), the series of processes is ended. On the other hand, when it is determined that the control program update in any of the indoor units 4A to 4G fails (step S41; No), the processing shifts to step S42.

In step S42, the analysis unit 315 extracts the various parameters affecting the success or failure of the control program update from the device update data. Then, in step S43, the analysis unit 315 analyzes a correlation relationship between the extracted various parameters and the information indicating the success or failure of the control program update.

In step S44, the analysis unit 315 determines whether or not the correlation relationship exists between the various parameters and the success or failure of the update. When it is determined that the correlation relationship exists (step S44; Yes), in step S45, the update execution unit 314 performs the processing for re-updating the control program on the indoor unit of the target. On the other hand, when it is determined that the correlation relationship does not exist (step S44; No), the processing shifts to step S47.

In step S46, the update execution unit 314 determines whether or not the re-update of the control program is successful. When it is determined that the re-update of the control program is successful (step S46; Yes), the processing returns to step S41. On the other hand, when it is determined that the re-update of the control program fails (step S46; No), the update execution unit 314 performs the processing for restoring the control program of the relevant indoor unit to the pre-update program in step S47. Then, the processing returns to step S41.

As described above, according to present Embodiment 4, when the device update data of each of the indoor units is analyzed after the control program update and the correlation relationship exists in the parameters included in the relevant data, the program re-update processing is performed on the indoor unit that does not operate normally. With this configuration, even when the update of the control program fails due to any cause in the indoor unit where the program update could be performed under normal circumstances, the control program of the relevant indoor unit can be more reliably updated than before.

Embodiments 1 to 4 of the present disclosure have been described above, but the present disclosure is not limited to above-described Embodiments 1 to 4 of the present disclosure, and various modifications and applications can be made in a range without departing from the gist of the present disclosure. Not only the server 1 but also a cloud that is wirelessly connected, for example, to the central management device 2 via a network may previously store the update program.

In addition, the update program and the pre-update program may also be saved in storage devices of different pieces of equipment. For example, the update program may also be saved in the server 1, and the pre-update program may also be saved in the outdoor unit 3. It is noted however that, in this case too, as in Embodiment 3, the influence on the communication traffic needs to be taken into account.

Furthermore, the equipment in which the programs are updated are not limited to the indoor unit 4 and the remote controller 5, and may also include any equipment as long as the equipment are disposed in the air-conditioning system 100. For example, when a relay, a ventilating device, and other devices are disposed in the air-conditioning system 100, the program update processing may also be executed by setting the equipment as the update targets.

### REFERENCE SIGNS LIST

1, 101 server 2 central management device 3 outdoor unit 4, 4A to 4G indoor unit 5 remote controller 10 LAN 20, 21 communication cable 31, 41 control substrate 32, 42 power source substrate 100, 150 air-conditioning system 110 communication device 111 server side storage device 120 processing circuit 200a, 200b commercial power source
201a, 201b switch 301, 401 transmission circuit 302, 402 microcomputer 302a, 402a memory 303 storage device 311 information obtaining unit 312 check processing unit 313 comparison determination unit 314 update execution unit 315 analysis unit.

1. An air-conditioning system comprising:
equipment involved in air-conditioning, the equipment including one or more pieces of equipment;
a high level device connected to the equipment and configured to control the equipment;
a storage device configured to store, by setting the high level device or the equipment as an update target device, an update program for updating a control program of the update target device and a pre-update program of the update target device, the update program and the pre-update program being previously stored in a server that is externally disposed;
a microcomputer provided at the high level device and configured to update the control program of the update target device,
the microcomputer being configured to
obtain the update program from the server and also obtain the pre-update program from the update target device, and store the obtained update program and the obtained pre-update program in the storage device;
compare a version of the update program with a version of the pre-update program; and
an update execution unit configured to update, when the version of the pre-update program is older than the version of the update program, the control program of the update target device into the update program stored in the storage device,
obtain, from the update target device in which the update of the control program is performed, device update data including parameters that affect a success or failure of the update when the update of the control program is performed and an update result,
analyze, based on the device update data, a correlation relationship of the parameters,
perform re-update of the control program of the update target device that does not operate normally when the update target device in which the control program is updated does not operate normally, and the correlation relationship exists in the parameters related to the update target device that does not operate normally, and
restore the control program of the update target device to the pre-update program stored in the storage device when the update target device that does not operate normally because of the re-update of the control program.

2. The air-conditioning system of claim 1, wherein
the storage device is disposed in the high level device.

3. The air-conditioning system of claim 1, wherein
the storage device is disposed in the server.

4. (canceled)

5. The air-conditioning system of claim 1, wherein
the microcomputer analyzes the correlation relationship between the parameters related to the update target device that operates normally by the update of the control program and the parameters related to the update target device that does not operate normally because of the update.

6. The air-conditioning system of claim 1, wherein
the update target device is the high level device, and
the high level device is an outdoor unit.

7. The air-conditioning system of claim 1, wherein
the update target device is the equipment,
the high level device is an outdoor unit, and
the equipment is an indoor unit, a remote controller, a relay, or a ventilating device.

8. An air-conditioning system comprising:
equipment involved in air-conditioning, the equipment including one or more pieces of equipment;
a high level device connected to the equipment and configured to control the equipment;
a storage device configured to store, by setting the high level device or the equipment as an update target device, an update program for updating a control program of the update target device and a pre-update program of the update target device, the update program and the pre-update program being previously stored in a server that is externally disposed;
a microcomputer provided at the high level device and configured to update the control program of the update target device,
the microcomputer being configured to
obtain the update program from the server and also obtain the pre-update program from the update target device, and store the obtained update program and the obtained pre-update program in the storage device;
compare a version of the update program with a version of the pre-update program;
update, when the version of the pre-update program is older than the version of the update program, the control program of the update target device into the update program stored in the storage device; and
analyze, based on device update data including parameters that affect a success or failure of the update when the update of the control program is performed and an update result, a correlation relationship of the parameters, the device update data being obtained from the update target device in which the update of the control program is performed, and
in a case where the update target device in which the control program is updated does not operate normally, when the correlation relationship exists in the parameters related to the update target device that does not operate normally, perform re-update of the control program of the update target device that does not operate normally.

9. A program update method in which equipment involved in air-conditioning, the equipment including one or more pieces of equipment, or a high level device connected to the equipment and configured to control the equipment is set as an update target device, and a control program of the update target device is updated, the program update method comprising:
obtaining an update program for updating the control program of the update target device from a server that is externally disposed;
obtaining a pre-update program from the update target device;
comparing a version of the update program with a version of the pre-update program;
updating, when the version of the pre-update program is older than the version of the update program, the control program of the update target device to the update program;
obtaining the device update data from the update target device in which the update of the control program is performed, the update data including parameters that affect a success or failure of the update when the update of the control program is performed and an update result;
analyzing, based on the obtained device update data, a correlation relationship of the parameters,
performing re-update of the control program of the update target device that does not operate normally when the update target device in which the control program is updated does not operate normally, and the correlation relationship exists in the parameters related to the update target device that does not operate normally because of the update, and
restoring, when the update target device in which the control program is updated does not operate normally because of the re-update of the control program, the control program of the update target device to the pre-update program.

10. An air-conditioning system of claim 1, wherein
the microcomputer is configured to perform re-update of the control program by using the parameters based on the analysis result obtained when the analysis unit determines that the correlation relationship exists in the parameters.
